(19) United States
(12) Patent Application Publication
(10) Pub. No.: US 2007/0144902 A1
(43) Pub. Date: Jun. 28, 2007

(54) Method for producing an electrode

(76) Inventors: Christine Schuelein, Germany (DE); Burcu Ulker, Germany (DE); Ingrid Weigel, Germany (DE); Juergen Schuelein, Germany (DE); Joerg Hassmann, Germany (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 10/569,779

(22) PCT Filed: Aug. 23, 2004
(86) PCT No.: PCT/EP04/09410

§ 371 Date: Sep. 27, 2006

(30) Foreign Application Priority Data
Aug. 29, 2003 (DE) 10340275.6

(51) Int. Cl. G01N 27/26

(52) U.S. Cl. 204/400

(57) ABSTRACT

The invention relates to a method for producing an electrode suitable for the sensitive and/or specific electrochemical detection of an analyte in an aqueous first liquid, said electrode being a composite electrode, a printed electrode or a carbon electrode which is superficially contacted with a hydrophobic second liquid prior to detection, and with the proviso that the electrode is not produced from a non-curing paste consisting of mineral oil and conductive particles only.

The invention relates to a method for producing an electrode suitable for the sensitive and/or specific electrochemical detection of an analyte in an aqueous solution, and to a use of this electrode.

Redox-active analytes can be examined and specified by means of electrochemical methods. The conversion of the analytes takes place at a working electrode. A reference electrode is used for currentless measurement of the voltage. The current that flows via the working electrode or the voltage that is dropped between the working electrode and the reference electrode is controlled by means of a counterelectrode. The electrochemical detection of analytes may be effected potentiometrically or amperometrically. In a potentiometric measurement protocol, the voltage dropped across the working and reference electrodes is measured in a time-dependent manner. A supervised current profile can be applied during this measurement. In the case of a constant current, this measurement is referred to as constant-current chronopotentiometry. The examination of analytes that are complexed or absorbed at a working electrode by means of constant-current chronopotentiometry is also referred to as constant-current chronopotentiometric stripping analysis or often just as chronopotentiometric stripping analysis (CPSA). Cathodic constant-current potentiometric stripping analysis comprises a method in which analytes are progressively oxidized by the application of a positive current. Conclusions about oxidizeable analytes can be drawn from these voltage-dependent oxidation reactions. Anodic constant-current potentiometric stripping analysis comprises a method in which a negative current is applied in order to be able to infer conclusions about reducible analytes from the voltage profile obtained.

In an amperometric measurement protocol, the voltage that is dropped between the reference electrode and the working electrode is altered according to a predetermined protocol by means of a counterelectrode. The current that flows via the working electrode is simultaneously measured. Redox-active analytes can be reduced or oxidized depending on the applied voltage. Through an evaluation of the current profile it is possible to draw conclusions about the analytes. An electrochemical measurement method using a stationary working electrode in which a current-voltage characteristic curve is recorded is also referred to as voltametry and the associated graphical representation is referred to as a voltamogram. For very sensitive measurements of redox processes, special measurement protocols have been developed in which capacitive processes that take place alongside the redox processes and influence the measurement are largely suppressed. One very efficient measurement protocol is differential pulse voltametry (DPV).

DE 100 22 750 A1 discloses a method for producing an area functionalized with identification elements, in which method a resin layer containing a substance with an identification function is deposited onto an electrically conductive body by electrodeposition. In order to prepare the resin, an unsaturated organic compound, such as a natural oil for example, may be converted into a resinous substance. The resin is made water-soluble by addition of a water-soluble acid. The resin may be suspended in water in which identification elements, such as an enzyme for example, may be dissolved. The resin may be deposited on an electrode, e.g. a carbon electrode, by applying a potential to the electrode.

EP 0 402 917 A2 discloses a biosensor containing electrodes made of metal. The electrodes are situated on a substrate. Substrate and electrodes may be coated with a thin layer made of a polymerized surface-active substance. In order to transfer the polymerized surface-active substance to the substrate, the substrate has to be made hydrophobic. For this purpose, it is possible for example to subject glass as substrate to alkaline treatment. For this purpose, it is possible to use a solution of an alkylating agent in hexane. The agent may be a carbon chain containing a methyl alkyl halide-silane groups, such as e.g. dimethyloctadecylchlorosilane.

WO 01/13103 A1 discloses electrodes having a surface coating made of an oxidized phenol compound. The surface coating is produced by oxidation of the phenol compound at the surface of the electrode. The surface coating contains a surface-active agent for improving the properties of the electrode.

Wang, J. et al. (1998) Analytica Chimica Acta, pages 197 to 203, discloses an electrochemical detection of DNA hybridization. In this case, an inosine-substituted, guanine-free DNA probe is immobilized at a carbon paste electrode. In order to produce the carbon paste electrode, graphite powder and mineral oil are mixed in a mass ratio of 70:30. This gives rise to a tough carbon paste which is then connected as an electrode. The formation of DNA hybrids with the immobilized DNA probe is detected chronopotentiometrically through the formation of a guanine oxidation peak of the hybridized DNA. What is disadvantageous about this method is that the electrode surface has to be renewed for each detection, that is to say it is necessary to perform a renewed immobilization of the DNA probe. Furthermore, the production of these electrodes is only poorly reproducible, that is to say that it is difficult to produce identical standardized electrodes. An immobilization of reactants through covalent binding to the carbon paste electrode can likewise only be achieved with difficulty. Moreover, an essential disadvantage of the carbon paste electrodes is that the latter are unstable and dissolve in many, in particular detergent-containing, solvents and buffers. All this has the overall effect that the results that can be obtained with carbon paste electrodes are only inadequately reproducible.

Carbon electrodes are usually pretreated prior to an electrochemical detection, in order to increase the sensitivity of the electrodes and the reproducibility of the detection. The electrode surface may be mechanically polished for this purpose. That is ruled out, however, if the electrodes are coated with a molecule required for the detection. Furthermore, the electrodes are usually conditioned electrochemically. In this case, redox-active substances situated at the electrodes are oxidized in order not to disturb the later electrochemical detection. At the same time, the surfaces of the electrodes are cleaned and hydrophilized, so that the electrodes can be wetted by liquid. The method is complicated and can only be automated with difficulty. It is also disadvantageous that molecules which are immobilized at the electrode and are intended to react with a substance to be analyzed may likewise be oxidized in this case. By way of example, guanine bases present in an immobilized DNA are oxidized. This impairs the hybridization properties of this DNA.

A further problem that occurs primarily in the case of a carbon electrode is the unspecific absorption of DNA at the electrode. This may lead to a high unspecific signal if a DNA that binds specifically to the electrode through hybridization is intended to be detected. In particular in the case of detection of DNA that is not provided with an electrochemically detectable marking substance, e.g. through oxidation of guanine bases, the unspecific signal may be too high in relation to the specific signal to enable a specific and/or sensitive detection. Attempts are made to solve the problem of unspecific binding by blocking unspecific absorption sites at the electrodes by means of various, usually biological, substances. Such substances are e.g. proteins, DNA or RNA. However, these methods are not very effective, particularly in the case of carbon electrodes.

The signals that have hitherto been able to be generated by means of screen printing electrodes can hardly be used for a sensitive detection of specific non-marked nucleic acids. Hitherto the signals have also not been able to be sufficiently improved by polishing or by an electrochemical conditioning of the screen printing electrode.

It is an object of the present invention to provide an alternative method for producing an electrode, which avoids the disadvantages mentioned above. In particular, the intention is to avoid an unspecific absorption at the electrode and/or to increase the sensitivity and/or specificity and/or reproducibility of the electrochemical detections that can be carried out with the electrode. Electrodes produced in identical fashion according to the method are intended to yield essentially uniform results during the electrochemical detection of an analyte. A further object of the invention consists in specifying a use of an electrode produced in accordance with the invention.

This object is achieved by means of the features of claims 1 and 17. Advantageous refinements emerge from the features of claims 2 to 16 and 18 to 24.

The invention provides a method for producing an electrode suitable for the sensitive and/or specific electrochemical detection of an analyte in an aqueous first liquid. In this case, the electrode is a composite electrode, a printed electrode or a carbon electrode which is contacted superficially with a hydrophobic second liquid prior to detection. The contact with the second liquid may be very short in this case. It suffices to dip the composite electrode, printed electrode or carbon electrode briefly into the second liquid and to remove excess second liquid immediately afterward, e.g. by wiping it away. The carbon electrode is an electrode containing elemental carbon at the surface. A composite electrode is an electrode in which conductive particles, e.g. made of carbon or a metal such as gold, are conductively bonded to one another by means of a binder. A printed electrode may be an electrode in which an electrode material is applied to a carrier in a method like screen printing. The electrode material is used instead of ink in this case, said electrode material usually comprising a curing binder and conductive particles. By way of example, the screen printing electrode paste “carbon/graphite paste C10903D14” from the company Gwent Electronic Materials Limited, Pontypool, Great Britain, may be used as electrode material. Such an electrode is referred to as a screen printing electrode. A printed electrode may also be an electrode in which the electrode material is applied to the carrier by means of a different method, such as e.g. a pad printing method. An electrode may be associated simultaneously with a plurality of the electrode types mentioned. An electrode may for example simultaneously be a composite electrode, printed electrode and carbon electrode. A composite electrode, printed electrode or carbon electrode in the sense of the invention is understood not to be an electrode which is formed from a non-curing paste comprising mineral oil and conductive particles only. Such a paste may be e.g. a carbon paste containing graphite and/or carbon black.

Electrodes produced by the method according to the invention can be used directly for the electrochemical detection of an analyte. In contrast to composite electrodes, printed electrodes or carbon electrodes that are not pretreated, that is to say are not contacted with the second liquid, comparatively uniform results can be obtained thereby. It has been shown that the electrodes produced according to the invention have a sensitivity, specificity and reproducibility during the detection of an analyte such as could hitherto only be achieved by means of electrochemical conditioning. This is particularly astonishing since it might be assumed that residues of the second liquid remaining on the surface of the electrode produced according to the invention block the electrode such that it is no longer accessible to the first liquid containing the analyte. This is not the case, however. In the case of printed electrodes, the method according to the invention makes it possible to generate an electrode surface that permits a highly specific detection of non-marked nucleic acids. Particularly in the case of the printed electrodes that are to be produced very cost-effectively, the problem hitherto has been that these electrodes have not been very suitable for specifically electrochemically detecting DNA bound to the printed electrodes by specific hybridization.

Furthermore, it is advantageous in the case of the method according to the invention that molecules, such as e.g. DNA, bound to the electrode can be kept functional and, in contrast e.g. to the case of electrochemical conditioning, do not lose binding capability, for example, through oxidation.

The method according to the invention makes it possible to produce very cost-effective electrodes for analysis, in particular environmental analysis, and diagnosis. Metal electrodes used here hitherto are expensive. In order to be able to be reused, these electrodes often have to be regenerated after the detection of an analyte. The use of cost-effective electrodes, for example based on carbon, such as pencil electrodes, and in particular printed electrodes, has hitherto failed due to the fact that these electrodes yielded results that were not very reproducible. The electrodes produced according to the invention may be e.g. such electrodes which are to be produced in a favorable manner and can be disposed of after a single detection of an analyte. A complicated regeneration is obviated.

The problem of high unspecific absorption, in particular of biomolecules such as DNA, surprisingly takes place only to a small extent in the case of the electrodes produced according to the invention. As a result, it is not necessary to saturate absorption sites at the electrodes by means of blocking reagents. Customary blocking reagents are e.g. proteins, DNA or RNA. They can likewise generate electrochemical signals that interfere with the detection.

The carbon electrode may be a pencil electrode, a graphite electrode, a pyrolytic graphite electrode, a highly orientated pyrolytic graphite electrode (HOPG electrode) or a glassy carbon electrode. A pencil electrode is a conventional pencil lead. The composite electrode or printed electrode may contain gold, platinum, silver, graphite and/or carbon black particles.

It is preferred for the second liquid to be an oil, preferably a mineral oil. Very good results have been obtained with this liquid. The composite electrode, printed electrode or carbon electrode may be contacted with the second liquid by dipping it into the second liquid or by spreading, spraying, coating or printing the second liquid on it. The printing may be effected e.g. in a pad printing method.

The contacting with the second liquid may be effected at 0° C. to 300° C., preferably at 18° C. to 25° C. The second liquid that adheres to the composite electrode, printed electrode or carbon electrode after contacting is advantageously removed from the electrode. This may be effected by simply wiping it away, spinning it away, for example in a centrifuge, causing it to flow away, rinsing it away or blowing it away with an air/gas stream. The composite electrode, printed electrode or carbon electrode may be polished, in particular after contacting with the second liquid. The electrode may be polished before and additionally after contacting with the second liquid. In this case, the polishing prior to contacting may be effected in comparatively coarse fashion, e.g. by means of an emery paper. After contacting, the polishing should be effected with little material removal, e.g. by polishing by means of a lint free cloth. The polishing improves the sensitivity of the electrode and the reproducibility of the results generated thereby. In order to further improve the properties of the electrode, the latter may be electrically and/or chemically conditioned, in particular after contacting with the second liquid. For chemical conditioning, the composite electrode, printed electrode or carbon electrode may be contacted with a detergent, preferably an ionic detergent, in particular SDS. For this purpose, the detergent may be contacted with the composite electrode, printed electrode or carbon electrode in an aqueous solution in a concentration of at least 0.1% (weight/volume), preferably at least 1.0% (weight/volume), in particular at least 5% (weight/volume). The concentration indication “% (weight/volume)” stands for “gram-volume %”. If the detergent is present e.g. in a concentration of 5% (weight/volume), then 5 g of detergent are contained in 100 ml of solution. The contacting with the detergent may be effected in the same way as the contacting with the second liquid.

The composite electrode, printed electrode or carbon electrode may be coated with a material, in particular a silane, preferably 3-(glycidyloxypropyl)-trimethoxysilane. The material is preferably a material which generates no electrochemical signal in a measurement range relevant to the detection of the analyte. The coating is preferably effected after contacting with the second liquid. Molecules, in particular catcher molecules that specifically bind the analyte, are bound to the composite electrode, printed electrode or carbon electrode or the coating material. The catcher molecules may be nucleic acids, in particular nucleic acids having a length of 5 to 100 nucleotides in each case, preferably nucleic acids having a length of 10 to 40 nucleotides in each case. Preferably, less than 20%, preferably less than 10%, in particular 0%, of the bases of the nucleic acids contain guanine. Instead they may contain inosine or 8-oxoguanine, which, during electrochemical detection, generates a different signal than the guanine which is preferably to be detected electrochemically. As a result it is possible to avoid the situation in which the catcher molecule provides bases which, during the electrochemical detection of guanine bases of a nucleic acid that has hybridized with the catcher molecule, themselves generate an electrochemical signal in the relevant measurement range. The oxidation signal generated by inosine is clearly to be distinguished from that of guanine.

Furthermore, the invention relates to the use of an electrode produced according to a method according to the invention in a method for the electrochemical detection of an analyte having the following steps of:

a) contacting the electrode with an aqueous first liquid containing the analyte, and

b) detecting the analyte at the electrode by means of a specific electrochemical reaction.

The electrode may be washed with at least one third aqueous liquid, in particular a buffer, between steps lit. a) and lit. b). As a result, if appropriate unspecifically adhering molecules can be removed and the specificity of the method can be increased. The analyte preferably has no electrochemical marking substance. An electrochemical marking substance is understood to mean an electrochemically detectable first molecule which is coupled to a second molecule in order to detect the second molecule electrochemically by means of the first molecule. In one refinement of the invention, the analyte is bound to the electrode, in particular to one of the catcher molecules bound to the electrode, during detection. By virtue of a specific binding to catcher molecules, it is furthermore possible to increase the specificity during the detection of the analyte.

The electrochemical reaction is preferably a redox reaction, which is detected in particular by means of a voltametric method, preferably differential pulse voltametry (DPV) or chronopotentiometric stripping analysis (CPSA).

The analyte is preferably an environmental pollutant or a biomolecule, in particular a nucleic acid. It is particularly advantageous if the nucleic acid is detected on the basis of the oxidation of its guanine basis. This does not require specific electrochemical marking of the nucleic acid. The electrode can be kept in the non-aqueous second liquid prior to detection. This is particularly advantageous for putting the electrode on the market. The electrode can then be sold in this liquid and is immediately fit for use.

The invention is explained in more detail below on the basis of exemplary embodiments. In the figures:

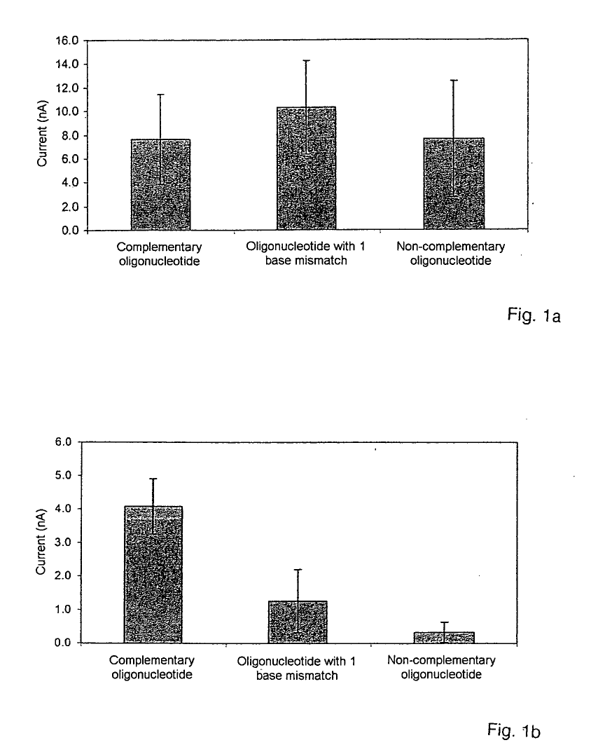

FIGS. 1a, b show DPV signals of an oxidation of the guanine bases of oligonucleotides bound to carbon electrodes which have been contacted with mineral oil or have not been contacted with mineral oil,

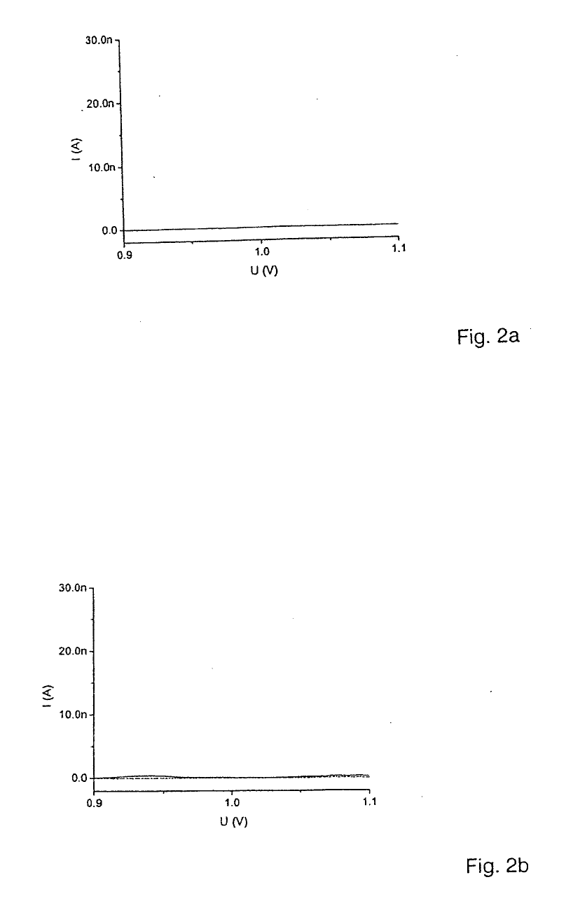

FIGS. 2a, b show DPV signals of an oxidation of the guanine bases of oligonucleotides bound to screen printing electrodes which have not been contacted with mineral oil,

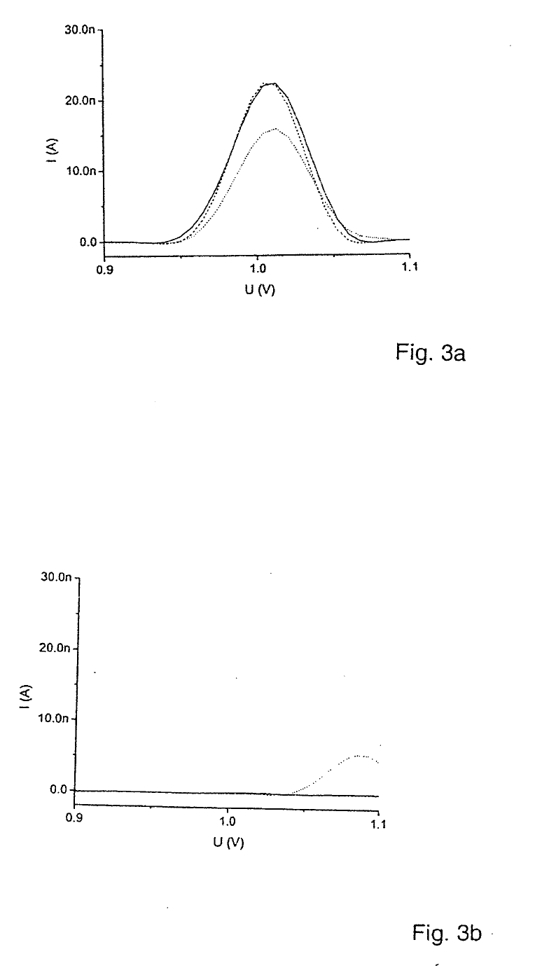

FIGS. 3a, b show DPV signals of the oxidation of the guanine bases of oligonucleotides bound to screen printing electrodes which have been contacted with mineral oil prior to detection, and

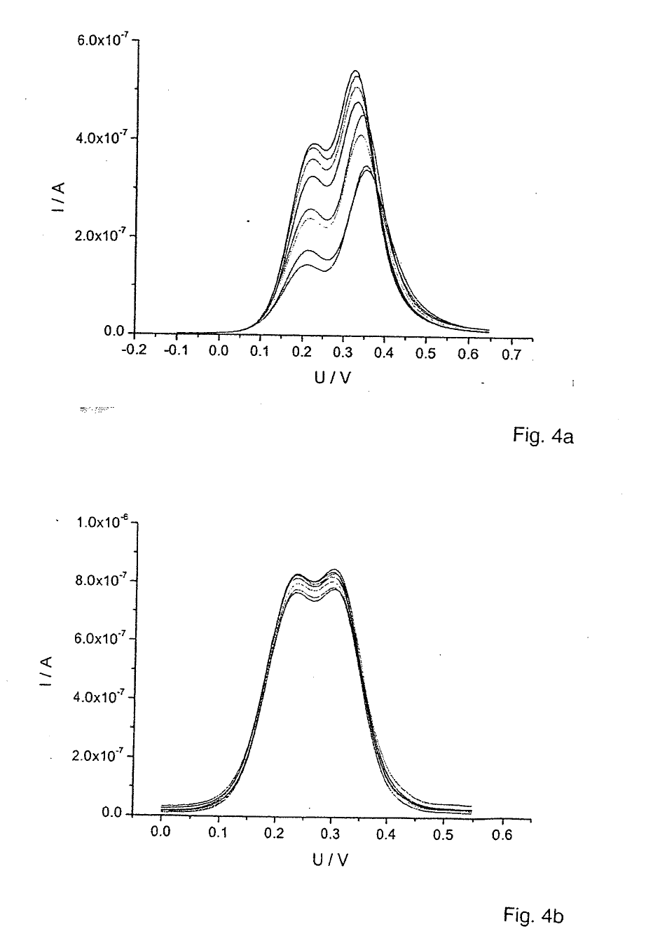

FIGS. 4a, b show detection of the electroactive substance (N, N-dimethyl-p-phenylenediamine) (DMPPB) by means of DPV on screen printing electrodes contacted with mineral oil and screen printing electrodes not contacted with mineral oil.

In the experiments whose results are illustrated in FIGS. 1b, 3a and 3b, the electrodes were contacted as follows:
1. immersion of the electrodes for 1 minute in mineral oil and
2. wiping away the excess oil using a soft, lint free cloth, so that a thin film of oil remains on the electrode surface.

The following further treatment was carried out with these electrodes and with the electrodes with which the results illustrated in FIGS. 1a, 2a and 2b were produced:
1. immersion for 15 minutes in in each case 150 μl 10% SDS (w/v) in water,
2. rinsing away using deionized water,
3. immersion for one hour in in each case 100 μl 1% 3-(glycidyloxypropyl)trimethoxysilane (v/v) in ethanol,
4. leave to dry for 15 minutes at 80° C., and
5. immersion for one hour in in each case 100 μl 0.1 mol/l Na₂CO₃, pH 9.5, 400 pmol/ml catcher oligonucleotide of the sequence SEQ ID NO 1 in accordance with the appended sequence listing.

The sequence of the catcher oligonucleotide originates from the gene coding for human TNF-alpha. The guanine base contained therein was replaced by an inosine base. At the 5′ end, the catcher oligonucleotide has an amino group bound via a spacer with a length of 7 carbon atoms (C7 chain). Via the amino group, the catcher oligonucleotide is bound to the coating of the electrodes during immersion.

The following procedure was adopted for the specific detection of a target DNA to be detected that was complementary to the catcher oligonucleotides:
1. immersion of the electrodes for 30 minutes in in each case 100 μl 1 nmol/ml target DNA in the hybridization buffer DigEasy (Roche Diagnostics GmbH, Sandhofer Straβe 116, 68305 Mannhein, Germany),
2. washing the electrodes for 10 minutes by immersing them in in each case 150 μl 1×SSC with 0.1% SDS, and
3. DPV in 0.1 M Na acetate buffer, pH 4.6.

In order to prepare 1×SSC, 20×SSC (175.3 g NaCl, 88.2 g sodium citrate-2H₂O and 800 ml H₂O, adjusted to pH 7 with HCl and filled with H₂O to a total volume of 1 liter) was diluted 1:20 with H₂O.

The following oligonucleotides were used in the experiments concerning the results illustrated in FIGS. 1a, 1b, 2a, 2b, 3a and 3b:
complementary oligonucleotide (SEQ ID NO 2),
oligonucleotide with one point mutation, that is to say 1 base mismatch, relative to the complementary oligonucleotide (SEQ ID NO 3), and
unspecific—that is to say not complementary to the catcher oligonucleotide—oligonucleotide (SEQ ID NO 4).

The results illustrated in FIGS. 1a and 1b were produced with pencil electrodes. FIG. 1a shows the results obtained with electrodes without mineral oil treatment, and FIG. 1b shows the results obtained with electrodes with mineral oil treatment. It is evident that a specific detection of a complementary oligonucleotide is possible with the electrodes treated with mineral oil, but is not possible with the electrodes not treated with mineral oil. The signal caused by the complementary oligonucleotide in the case of electrodes not contacted with mineral oil does not differ in its intensity from the signal caused by a non-complementary oligonucleotide or an oligonucleotide with one base mismatch.

The results illustrated in FIGS. 2a, 2b, 3a, 3b, 4a and 4b were produced with screen printing electrodes. In order to produce the electrodes, the screen printing electrode paste “carbon/graphite paste C10903D14” from the company Gwent Electronic Materials Limited, Pontypool, Great Britain, was applied to a carrier and left to dry.

FIG. 2a shows the result obtained with the complementary oligonucleotide (SEQ ID NO 2) and FIG. 2b shows the result obtained with the non-complementary oligonucleotide (SEQ ID NO 4). It was evident that without oil treatment neither a signal generated by a complementary oligonucleotide nor a signal generated by a non-complementary oligonucleotide can be detected. The result illustrated in FIG. 3a was obtained with the complementary oligonucleotide and the result illustrated in FIG. 3b was obtained with the non-complementary oligonucleotide. FIG. 3a shows, in comparison with FIGS. 2a, 2b and 3b, that the treatment with mineral oil makes it possible in the first place to specifically detect a complementary oligonucleotide on the basis of guanine oxidation with screen printing electrodes.

The experimental results illustrated in FIGS. 4a and 4b were generated as follows:

Carriers each having nine screen printing electrodes were used for the measurement. With these screen printing electrodes, DPV voltamograms of the substance DMPPD were recorded simultaneously using a platinum counterelectrode and an Ag/AgCl reference electrode. For this purpose, the screen printing electrodes were dipped into 0.1% HAc/NaAC, pH 4.6, 10⁻⁴ mol/l DMPPD.

FIG. 4a shows the measurement with screen printing electrodes which, prior to measurement, were polished with a lint free cloth but were not contacted with mineral oil. It is evident in this case that the nine screen printing electrodes present on the carrier generate different signals for the same substance present in an identical concentration.

FIG. 4b shows signals generated by means of screen printing electrodes which were dipped in mineral oil for 5 minutes and subsequently polished with a lint free cloth. The signals are significantly more uniform than the signals generated by means of screen printing electrodes without treatment with mineral oil. Furthermore, the signal strength for all the signals is greater than in the case of the signals generated by means of screen printing electrodes that have not been pretreated.

1-24. (canceled)

25. A method of preparing an electrode for electrochemical detection of at least one analyte in an aqueous first liquid, the method comprising:
providing an electrode selected from the group consisting of a composite electrode, a printed electrode, a carbon electrode, and any combination thereof; wherein the electrode does not include a non-curing paste consisting of mineral oil and conductive particles;
applying a hydrophobic second liquid to the electrode; and
attaching a catcher molecule to the electrode, wherein the catcher molecule specifically binds the analyte.

26. The method of claim 25, wherein the electrode is a carbon electrode selected from the group consisting of a pencil electrode, a graphite carbon electrode, a pyrolytic graphite electrode, a highly orientated pyrolytic graphite electrode (HOPG electrode), a glassy carbon electrode, and any combination thereof.

27. The method of claim 25, wherein the electrode is a composite electrode or printed electrode, wherein the electrode comprises particles selected from the group consisting of gold particles, platinum particles, silver particles, graphite particles, carbon black particles, and any combination thereof.

28. The method of claim 25, wherein the second liquid comprises an oil.

29. The method of claim 28, wherein the oil is a mineral oil.

30. The method of claim 25, wherein the second liquid is applied by one of the processes selected from the group consisting of dipping, spreading, spraying, coating, printing, and any combination thereof.

31. The method of claim 30, wherein the printing comprises pad printing.

32. The method of claim 25, wherein the temperature of the second liquid is between about 0° C. to about 300° C.

33. The method of claim 25, wherein the temperature of the second liquid is between about 18° C. to about 25° C.

34. The method of claim 25, the method further comprising removing second liquid that adheres to the electrode.

35. The method of claim 34, wherein the removing comprises at least one process selected from the group consisting of wiping, spinning, flowing, blowing with at least one of a stream of gas and a stream of air, and rinsing.

36. The method of claim 25, wherein the preparation of the electrode further comprises polishing the electrode.

37. The method of claim 25, wherein the preparation of the electrode further comprises conditioning the electrode, and wherein the conditioning comprises at least one of electrically conditioning and chemically conditioning.

38. The method of claim 37, wherein the conditioning is performed after applying the second liquid to the electrode.

39. The method of claim 37, wherein the conditioning comprises contacting the electrode with a detergent.

40. The method of claim 39, wherein the detergent is an ionic detergent.

41. The method of claim 40, wherein the detergent is SDS.

42. The method of claim 39, wherein the detergent is in an aqueous solution in a concentration of at least 0.1% (weight/volume).

43. The method of claim 39, wherein the detergent is in an aqueous solution in a concentration of at least 1% (weight/volume).

44. The method of claim 39, wherein the detergent is in an aqueous solution in a concentration of at least 5% (weight/volume).

45. The method of claim 25, wherein the preparation of the electrode further comprises, after applying the second liquid to the electrode, coating the electrode with a material that does not generate an electrochemical signal in a measurement range relevant to the detection of the analyte.

46. The method of claim 45, wherein the material used to coat the electrode is a silane.

47. The method of claim 25, wherein the catcher molecule comprises a nucleic acid having a length of about 5 to about 100 nucleotides.

48. The method of claim 47, wherein the length is 10 to 40 nucleotides.

49. The method of claim 47, wherein less than 20% of the bases of the nucleic acid are guanine.

50. The method of claim 47, wherein less than 10% of the bases of the nucleic acid are guanine.

51. A method of electrochemically detecting at least one analyte in an aqueous first liquid, the method comprising:
providing a screen printing electrode; wherein the electrode does not include a non-curing paste consisting of mineral oil and conductive particles;
applying a second liquid comprising mineral oil to the electrode superficially;
removing excess mineral oil to leave a layer of mineral oil on the electrode;
attaching a catcher molecule to the electrode, wherein the catcher molecule comprises an amino group, a carbon spacer chain, and a first nucleic acid comprising a first nucleotide sequence; wherein the first nucleotide sequence is complementary to a second nucleotide sequence; wherein any guanine bases of the first nucleotide sequence have been replaced by inosine.
contacting the electrode with the aqueous first liquid containing the analyte, wherein the analyte comprises a second nucleic acid comprising the second nucleotide sequence;
washing the electrode with at least an aqueous third liquid comprising 1×SSC with 0.1% SDS; and
detecting the presence or absence of the analyte using differential pulse voltammetry (DPV) in 0.1 M Na acetate buffer at pH 4.6.

52. A method of electrochemically detecting at least one analyte in an aqueous first liquid, the method comprising:
providing an electrode selected from the group consisting of a composite electrode, a printed electrode, a carbon electrode, and any combination thereof; wherein the electrode does not include a non-curing paste consisting of mineral oil and conductive particles;
applying a hydrophobic second liquid superficially to the electrode;
attaching a catcher molecule to the electrode, wherein the catcher molecule specifically binds the analyte;
contacting the electrode with the aqueous first liquid containing the analyte;
washing the electrode with at least an aqueous third liquid; and
detecting the analyte at the electrode.

53. The method of claim 52, wherein the aqueous liquid is a buffer.

54. The method of claim 52, wherein the analyte does not comprise an electrochemical marking substance.

55. The method of claim 52, wherein the analyte is bound to the electrode during detection.

56. The method of claim 55, wherein the analyte is bound to a catcher molecule.

57. The method of claim 52, wherein the detecting comprises the detecting of a redox reaction.

58. The method of claim 52, wherein the detecting comprises a voltammetric method.

59. The method of claim 58, wherein the voltammetric method is selected from the group consisting of differential pulse voltammetry (DPV), chronopotentiometric stripping analysis (CPSA), and any combination thereof.

60. The method of claim 52, wherein the analyte is selected from the group consisting of an environmental pollutant, a biomolecule, and a combination thereof.

61. The method of claim 60, wherein the catcher molecule comprises a first nucleotide sequence complementary to a second nucleotide sequence, wherein the biomolecule comprises a nucleic acid comprising the second nucleotide sequence, and wherein the first nucleotide sequence has had any guanine bases replaced with inosine bases.


SEQUENCE LISTING (4 sequences)

SEQ ID NO: 1 - DNA, 20 bp, Homo sapiens
  modified_base (4)..(4): I
cctgccccaatccctttatt

SEQ ID NO: 2 - DNA, 20 bp, Homo sapiens
aataaagggattggggcagg

SEQ ID NO: 3 - DNA, 20 bp, Homo sapiens
aataaagggatgggggcagg

SEQ ID NO: 4 - DNA, 20 bp, Artificial
  Arbitrary random sequence
gggaggtttcgtatagggaa